(19) United States
(12) Patent Application Publication
(10) Pub. No.: US 2019/0130185 A1
(43) Pub. Date: May 2, 2019

(54) Visualization of Tagging Relevance to Video

(71) Applicant: International Business Machines Corporation, Armonk, NY (US)

(72) Inventors: Mark Delaney, Raleigh, NC (US); Robert Grant, Austin, TX (US); Trudy L. Hewitt, Cary, NC (US); Jana H. Jenkins, Raleigh, NC (US)

(21) Appl. No.: 15/800,238

(22) Filed: Nov. 1, 2017

(51) Int. Cl. G06K 9/00; G06F 17/30; G11B 27/034

(52) U.S. Cl. CPC G06K 9/00711; G06F 17/30796; H04H 60/58; G06F 17/30793; G11B 27/034; G06F 17/30843

(57) ABSTRACT

Visualizing where and how a tag was generated for a video being played is provided. Topics in a video are determined by evaluating content of the video using audio, visual, and text recognition. For each instance in the video where a topic is determined to appear: a) a general tag is assigned that includes a description of the topic and a timestamp indicating where the general tag appears in the video; and b) a sub-content tag is assigned that includes a description of a format type of the content at a location in the video corresponding to the timestamp of the general tag. The sub-content tag is associated with the general tag. Either general tags or sub-content tags are displayed when rendering the video. The general tags are displayed in text and the sub-content tags are displayed as icons indicating the format type of each of the general tags.

### BACKGROUND

### 1. Field

The disclosure relates generally to tagging videos and more specifically to determining a topic in a video by analyzing the content of the video, generating a general content tag corresponding to the topic and a set of one or more content format-derived tags identifying a type of format the general content tag is derived from, such as visual content, audio content, and/or textual content, within the video, and identifying the specific location where each respective content format-derived tag is located within the video using a corresponding graphic icon, such as visual icon, audio icon, or text icon, at a corresponding timestamp on a progress bar of the video.

### 2. Description of the Related Art

People use tags to aid in classification of electronic objects, mark ownership of electronic documents, and indicate online identities, for example. Tags may take the form of keywords, images, or other identifying marks. Computer-based search algorithms use these tags to rapidly explore stored information and records.

Tagging gained popularity in image sharing and social networking websites. These websites allow users to create tags to categorize content using keywords. For example, photograph sharing websites allow users to add their own tags to each of their pictures, constructing flexible and easy metadata to make their pictures highly searchable. In addition, other social media websites, such as video sharing websites, also implement tagging to make videos highly searchable. Thus, tags make it possible for others to easily find content regarding a specific topic or subject matter.

Further, people create and use hashtags by placing the number sign or pound sign “#” (also known as a hash) in front of a string of alphanumeric characters, which is usually a word or unspaced phrase, in or at the end of a message. A hashtag may contain letters, digits, and underscores. Searching for a particular hashtag will yield each message that is tagged with that particular hashtag. For example, on a photograph sharing website, the hashtag #bluesky allows a user to find all posts that are tagged using that hashtag. As another example, if a user of a social media messaging service searches for #yum, the user will get a list of messages regarding tasty food and beverages.

### SUMMARY

According to one illustrative embodiment, a computer-implemented method for visualizing where and how a tag was generated for a video being played is provided. Topics in a video are determined by evaluating content of the video using audio, visual, and text recognition. For each instance in the video where a topic is determined to appear: a) a general tag is assigned that includes a description of the topic and a timestamp indicating where the general tag appears in the video; and b) a sub-content tag is assigned that includes a description of a format type of the content at a location in the video corresponding to the timestamp of the general tag. The sub-content tag is associated with the general tag. Either general tags or sub-content tags are displayed when rendering the video. The general tags are displayed in text and the sub-content tags are displayed as icons indicating the format type of each of the general tags. According to other illustrative embodiments, a computer system and computer program product for visualizing where and how a tag was generated for a video being played are provided.

### BRIEF DESCRIPTION OF THE DRAWINGS

FIG. 1 is a diagram of a data processing system in which illustrative embodiments may be implemented;

FIG. 2 is a diagram illustrating examples of content format-derived icons in accordance with an illustrative embodiment;

FIG. 3 is a diagram illustrating display of content format-derived icons on a video progress bar in accordance with an illustrative embodiment;

FIG. 4 is a diagram illustrating display of sets of content format-derived icons within a list of general content tags in accordance with an illustrative embodiment;

FIG. 5 is a diagram illustrating display of aggregate icon timestamps in accordance with an illustrative embodiment;

FIG. 6 is a flowchart illustrating a process for assigning an appropriate content format-derived icon to each respective general content tag within a video in accordance with an illustrative embodiment; and

FIG. 7 is a flowchart illustrating a process for displaying a set of content format-derived icons on a video progress bar in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

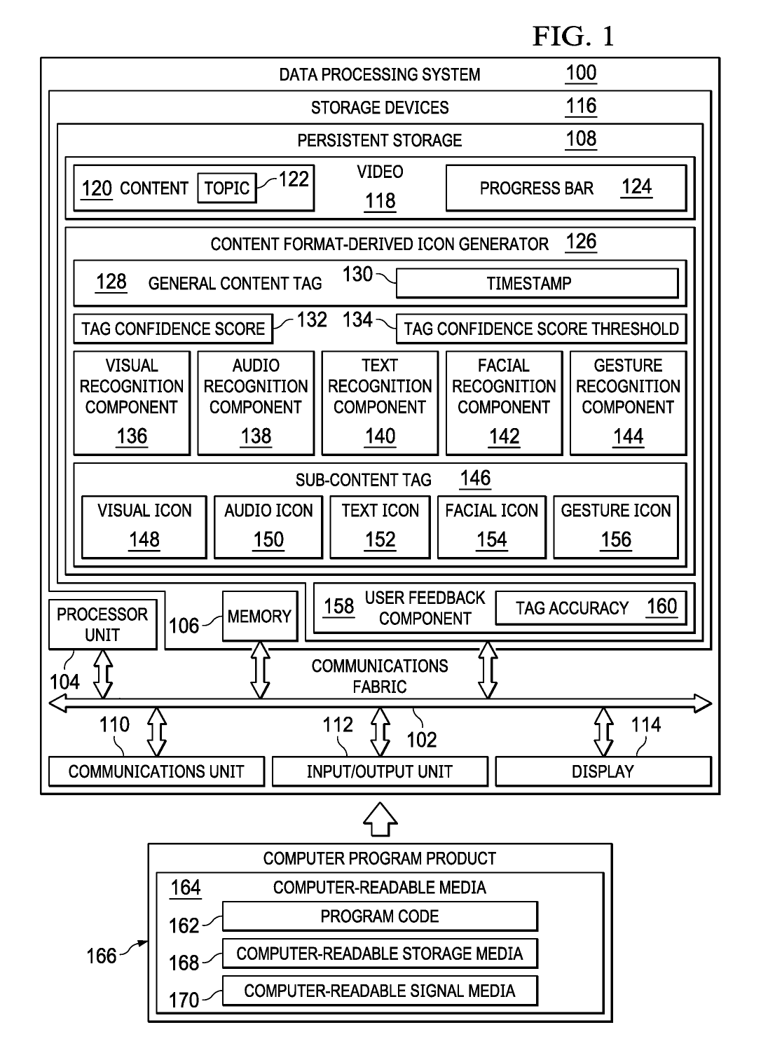

With reference now to the figures, and in particular, with reference to FIG. 1, a diagram of data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 depicts a diagram of a data processing system in accordance with an illustrative embodiment. Data processing system 100 is an example of a hardware device in which computer readable program code or program instructions implementing processes of illustrative embodiments may be located. Data processing system 100 may be, for example, a computer, such as a desktop or personal computer, a handheld computer, a laptop computer, and the like, a smart phone, a smart television, a digital video recorder, or any other device capable of playing a video. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software applications and programs that may be loaded into memory 106. In this example, processor unit 104 may be a set of one or more hardware processor devices or a single processor with a multi-processor core, depending on the particular implementation. Further, different illustrative embodiments may implement processor unit 104 using multiple heterogeneous processors or using multiple processors of the same type.

Memory 106 and persistent storage 108 are examples of storage devices 116. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 106, in these examples, may be, for example, a random-access memory, or any other suitable volatile or non-volatile storage device. Persistent storage 108 may take various forms, depending on the particular implementation. For example, persistent storage 108 may contain one or more devices. For example, persistent storage 108 may be a hard drive, a flash memory, a rewritable optical disk, a rewritable magnetic tape, or some combination of the above. The media used by persistent storage 108 may be removable. For example, a removable hard drive may be used for persistent storage 108.

In this example, persistent storage 108 stores video 118. Video 118 may represent any type of video, such as, for example, a prerecorded video or a streaming video, capable of being played on data processing system 100. Video 118 includes content 120. Content 120 contains topic 122. Topic 122 may represent any topic or subject matter. Further, topic 122 may represent a set of one or more topics included within content 120 of video 118. Furthermore, video 118 includes progress bar 124. Progress bar 124 indicates timeline playing progress of video 118. Moreover, it should be noted that video 118 may represent a plurality of different videos.

Also in this example, persistent storage 108 stores content format-derived icon generator 126. However, it should be noted that even though content format-derived icon generator 126 is illustrated as residing in persistent storage 108, in an alternative illustrative embodiment content format-derived icon generator 126 may be a separate component of data processing system 100. For example, content format-derived icon generator 126 may be a hardware component coupled to communication fabric 102. Alternatively, content format-derived icon generator 126 may be a combination of hardware and software components.

Content format-derived icon generator 126 controls the process of determining topic 122 in video 118 by analyzing content 120 of video 118, generating general content tag 128 corresponding to topic 122 and a set of one or more sub-content tags identifying a type of format general content tag 128 is derived from, such as visual content, audio content, and/or textual content, within video 118, and identifying the specific locations where respective sub-content tags are located within video 118 using corresponding graphic icons, such as visual icons, audio icons, and/or text icons, at corresponding timestamps on progress bar 124 of video 118. General content tag 128 represents a tag or #hashtag corresponding to topic 122, which may be any topic or subject matter, such as, for example, the topic of baseball. Timestamp 130 represents a set of one or more locations where general content tag 128 corresponding to topic 122 is found in video 118.

Content format-derived icon generator 126 generates general content tag 128 after analyzing content 120 to determine topic 122. However, it should be noted that content format-derived icon generator 126 also may generate tag confidence score 132 for general content tag 128. Tag confidence score 132 represents a level of confidence in the accuracy of general content tag 128 with regard to topic 122. If tag confidence score 132 is greater than tag confidence score threshold 134, then content format-derived icon generator 126 adds general content tag 128 to video 118. Conversely, if tag confidence score 132 is less than or equal to tag confidence score threshold 134, then content format-derived icon generator 126 may not add general content tag 128 to video 118.

Also in this example, content format-derived icon generator 126 includes image recognition component 136, audio recognition component 138, text recognition component 140, facial recognition component 142, and gesture recognition component 144. Content format-derived icon generator 126 utilizes image recognition component 136, audio recognition component 138, text recognition component 140, facial recognition component 142, and gesture recognition component 144 to generate the set of one or more sub-content tags, such as sub-content tag 146. Sub-content tag 146 identifies the type of content format, such as, for example, a visual content format, an audio content format, a textual content format, a facial content format, and/or a gesture content format, which general content tag 128 is derived from.

For example, image recognition component 136 may generate sub-content tag 146 based on image recognition component 136 detecting an image of an object, such as, for example, a baseball, corresponding to topic 122 within video 118. Audio recognition component 138 may generate sub-content tag 146 based on audio recognition component 138 detecting an audible sound, such as, for example, the word baseball being spoken, corresponding to topic 122 within video 118. Text recognition component 140 may generate sub-content tag 146 based on text recognition component 140 detecting alphanumeric characters, such as, for example, the printed word baseball, corresponding to topic 122 within video 118. Facial recognition component 142 may generate sub-content tag 146 based on facial recognition component 142 detecting facial features, such as, for example, the face of a baseball player, corresponding to topic 122 within video 118. Gesture recognition component 144 may generate sub-content tag 146 based on gesture recognition component 144 detecting specified movements, such as, for example, a home plate umpire calling a baseball player out sliding into home, corresponding to topic 122 within video 118.

After image recognition component 136, audio recognition component 138, text recognition component 140, facial recognition component 142, and/or gesture recognition component 144 generate the set of one or more sub-content tags, content format-derived icon generator 126 generates and assigns a corresponding graphic image, such as visual icon 148, audio icon 150, text icon 152, facial icon 154, and/or gesture icon 156, to each respective sub-content tag in the set. Visual icon 148 may be, for example, a graphic image of an eye. Audio icon 150 may be, for example, a graphic image of an ear. Text icon 152 may be, for example, a graphic image of the capital letter “T”. Facial icon 154 may be, for example, a graphic image of a human face. Gesture icon 156 may be, for example, a graphic image of a hand waving.

Further, content format-derived icon generator 126 overlays the assigned icons on progress bar 124 of video 118 at locations corresponding to each timestamp 130 associated with general content tag 128 to indicate the format of content 120 the set of sub-content tags where derived from. Furthermore, content format-derived icon generator 126 utilizes user feedback component 158 to determine tag accuracy 160. User feedback component 158 requests and receives feedback from users of data processing system 100 viewing video 118 on display 114 regarding the accuracy of general content tag 128 and sub-content tag 146. Content format-derived icon generator 126 utilizes the user feedback to increase tag accuracy 160 in video 118 and other videos in the future.

Communications unit 110, in this example, provides for communication with other computers, data processing systems, and devices via a network. Communications unit 110 may provide communications using both physical and wireless communications links. The physical communications link may utilize, for example, a wire, cable, universal serial bus, or any other physical technology to establish a physical communications link for data processing system 100. The wireless communications link may utilize, for example, shortwave, high frequency, ultra-high frequency, microwave, wireless fidelity (WiFi), Bluetooth® technology, near field communication, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 100.

Input/output unit 112 allows for the input and output of data with other devices that may be connected to data processing system 100. For example, input/output unit 112 may provide a connection for user input through a keyboard, keypad, mouse, and/or some other suitable input device. Display 114 provides a mechanism to display information to a user and may include touch screen capabilities to allow the user to make on-screen selections through user interfaces or input data, for example.

Instructions for the operating system, applications, and/or programs may be located in storage devices 116, which are in communication with processor unit 104 through communications fabric 102. In this illustrative example, the instructions are in a functional form on persistent storage 108. These instructions may be loaded into memory 106 for running by processor unit 104. The processes of the different embodiments may be performed by processor unit 104 using computer-implemented program instructions, which may be located in a memory, such as memory 106. These program instructions are referred to as program code, computer usable program code, or computer readable program code that may be read and run by a processor in processor unit 104. The program code, in the different embodiments, may be embodied on different physical computer readable storage devices, such as memory 106 or persistent storage 108.

Program code 162 is located in a functional form on computer readable media 164 that is selectively removable and may be loaded onto or transferred to data processing system 100 for running by processor unit 104. Program code 162 and computer readable media 164 form computer program product 166. In one example, computer readable media 164 may be computer readable storage media 168 or computer readable signal media 170. Computer readable storage media 168 may include, for example, an optical or magnetic disc that is inserted or placed into a drive or other device that is part of persistent storage 108 for transfer onto a storage device, such as a hard drive, that is part of persistent storage 108. Computer readable storage media 168 also may take the form of a persistent storage, such as a hard drive, a thumb drive, or a flash memory that is connected to data processing system 100. In some instances, computer readable storage media 168 may not be removable from data processing system 100.

Alternatively, program code 162 may be transferred to data processing system 100 using computer readable signal media 170. Computer readable signal media 170 may be, for example, a propagated data signal containing program code 162. For example, computer readable signal media 170 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 162 may be downloaded over a network to persistent storage 108 from another device or data processing system through computer readable signal media 170 for use within data processing system 100. For instance, program code stored in a computer readable storage media in a data processing system may be downloaded over a network from the data processing system to data processing system 100. The data processing system providing program code 162 may be a server computer, a client computer, or some other device capable of storing and transmitting program code 162.

The different components illustrated for data processing system 100 are not meant to provide architectural limitations to the manner in which different embodiments may be implemented. The different illustrative embodiments may be implemented in a data processing system including components in addition to, or in place of, those illustrated for data processing system 100. Other components shown in FIG. 1 can be varied from the illustrative examples shown. The different embodiments may be implemented using any hardware device or system capable of executing program code. As one example, data processing system 100 may include organic components integrated with inorganic components and/or may be comprised entirely of organic components excluding a human being. For example, a storage device may be comprised of an organic semiconductor.

As another example, a computer readable storage device in data processing system 100 is any hardware apparatus that may store data. Memory 106, persistent storage 108, and computer readable storage media 168 are examples of physical storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

Today, people assign tags to videos to describe the content of the videos. However, in the course of developing illustrative embodiments, it was discovered that no method currently exists for a viewer of a video to interactively and visually see where and how a content tag was generated with regard to the video being viewed. Illustrative embodiments generate and map content format-derived graphic icons to general content tags for display on a progress bar of a video when a topic referenced by a content tag or #hashtag was derived from visual content (e.g., pictures, graphics, or images), audio content (e.g., spoken words, singing, music, sounds), and/or textual content (e.g., alphanumeric characters, special characters, or symbols) within the video. It should be noted that the terms “tags” and “hashtags” are interchangeable terms with regard to this specification.

After illustrative embodiments determine the format type of the content corresponding to each instance of the general content tag within the video, illustrative embodiments assign an applicable content format-derived icon to a timestamp corresponding to where the general content tag/#hashtag is located within the video. Illustrative embodiments overlay the applicable content format-derived icon over the video progress bar at locations of timestamps corresponding to the general content tag. As a result, illustrative embodiments allow a user of a device playing the video to select by, for example, clicking on, hovering over, and the like, a displayed content format-derived icon on the video progress bar to find where the content corresponding to the general content tag is located within the video.

Illustrative embodiments may be applied to recorded video content or to live streaming video content where illustrative embodiments generate general content tags and corresponding content format-derived icons in real time for a user to view on a video progress bar. Example content format-derived icons that illustrative embodiments may utilize to portray how a general content tag/#hashtag was derived from the content of a video may include, for example, a visual content format type icon, such as an eye graphic, an audio content format type icon, such as an ear graphic, a textual content format type icon, such as a capital “T” graphic, a facial content format type icon, such as a face graphic, a gesturing content format type icon, such as a waving hand graphic, and the like.

Illustrative embodiments utilize tagging content points within a video relative to: 1) generalized content tags (e.g., when a person starts talking about the topic of baseball in the video, illustrative embodiments assign a general baseball content tag and corresponding timestamp to identify the specific location within the video where the topic of baseball was mentioned); and 2) sub-content format type tags that identify the type of format in which the topic appears within the content of the video (e.g., illustrative embodiments may assign a graphic icon of an ear at a point in the video where the word baseball was spoken (i.e., audio content type) or a graphic icon of an eye at a point in the video where a baseball was shown (i.e., visual content type). As a result, illustrative embodiments may assign a plurality of different content format-derived icons to the single general content tag of baseball at multiple timestamp locations within the video. Thus, illustrative embodiments provide a user with a quick visual in the video progress bar that illustrates how the tagged topic of baseball is referenced, such as, for example, visually, verbally, or textually within the video content. As a result, illustrative embodiments provide enhanced video player functionality and capability and improve user experience.

In addition, illustrative embodiments may allow the user to see an aggregation and/or filtering of timestamps within the video content at a higher granularity. For example, the user may select a visual (e.g., eye) icon within the video progress bar to see a set of timestamps corresponding to all visual icons or a selected portion of visual icons overlaid on the video progress bar that relate to the general content tag of baseball. Furthermore, illustrative embodiments may assign tags to live streaming video with minimal delay and adjust for tagging confidence as more of the video is streamed. For example, illustrative embodiments may assign a lower confidence score (e.g., 50% confidence) corresponding to a tag when only a portion of a baseball is shown at the beginning of the video, but later in the video an entire baseball is shown raising the confidence score corresponding to the tag. If the confidence score for a respective tag is above a predefined confidence score threshold, then illustrative embodiments add the tag to the video. Moreover, illustrative embodiments may utilize a user feedback component to improve the accuracy of and confidence in general content tags and sub-content format type tags.

As an illustrative use case scenario, a user seeks to find an audio clip of someone saying the word baseball for a project the user is working on. The user finds a video with the corresponding general content tag of baseball. The user plays the video on a device implementing illustrative embodiments. As illustrative embodiments play the video, illustrative embodiments display a set of one or more content format-derived icons (e.g., a visual icon, an audio icon, and/or text icon) corresponding to the general content tag of baseball at locations on the video progress bar associated with the general content tag of baseball. The user selects an audio icon on the video progress bar (e.g., hovers over the audio icon with a cursor) to locate each instance within the video where the word baseball was uttered in speech or song, for example. Consequently, illustrative embodiments enable the user to quickly jump to specific timestamp locations within the video where baseball is referenced and tagged from an audio content source.

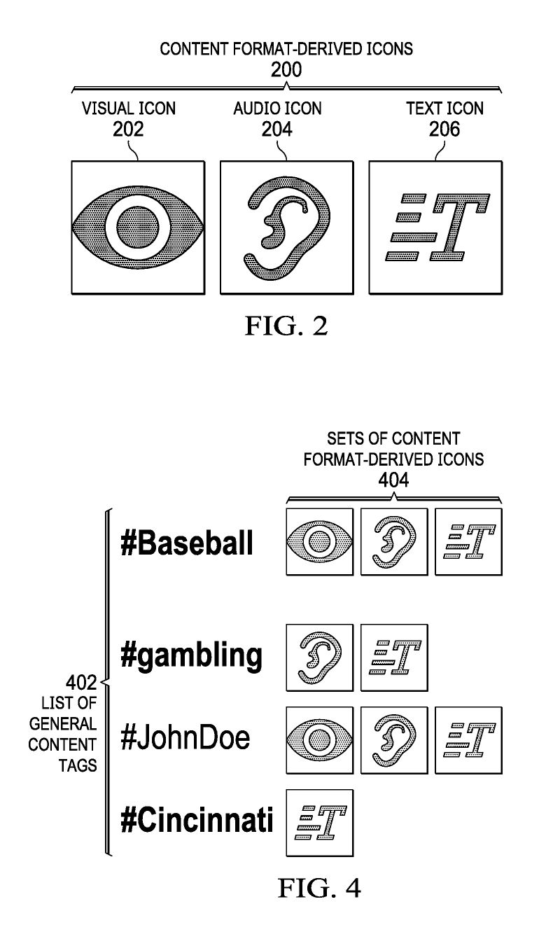

With reference now to FIG. 2, a diagram illustrating examples of content format-derived icons are depicted in accordance with an illustrative embodiment. Content format-derived icons 200 represent a set of graphical images corresponding to how a set of sub-content tags, such as sub-content tag 146 in FIG. 1, were derived from video content, such as content 120 of video 118 in FIG. 1. In this example, content format-derived icons 200 include visual icon 202, audio icon 204, and text icon 206, such as visual icon 148, audio icon 150, and text icon 152 in FIG. 1. Also in this example, visual icon 202 is illustrated as an eye graphic, audio icon 204 is illustrated as an ear graphic, and text icon 206 is illustrated as a capital “T” graphic. However, it should be noted that illustrative embodiments are not limited to such. In other words, different illustrative embodiments may represent visual icon 202, audio icon 204, and text icon 206 using any type of corresponding graphic image or picture.

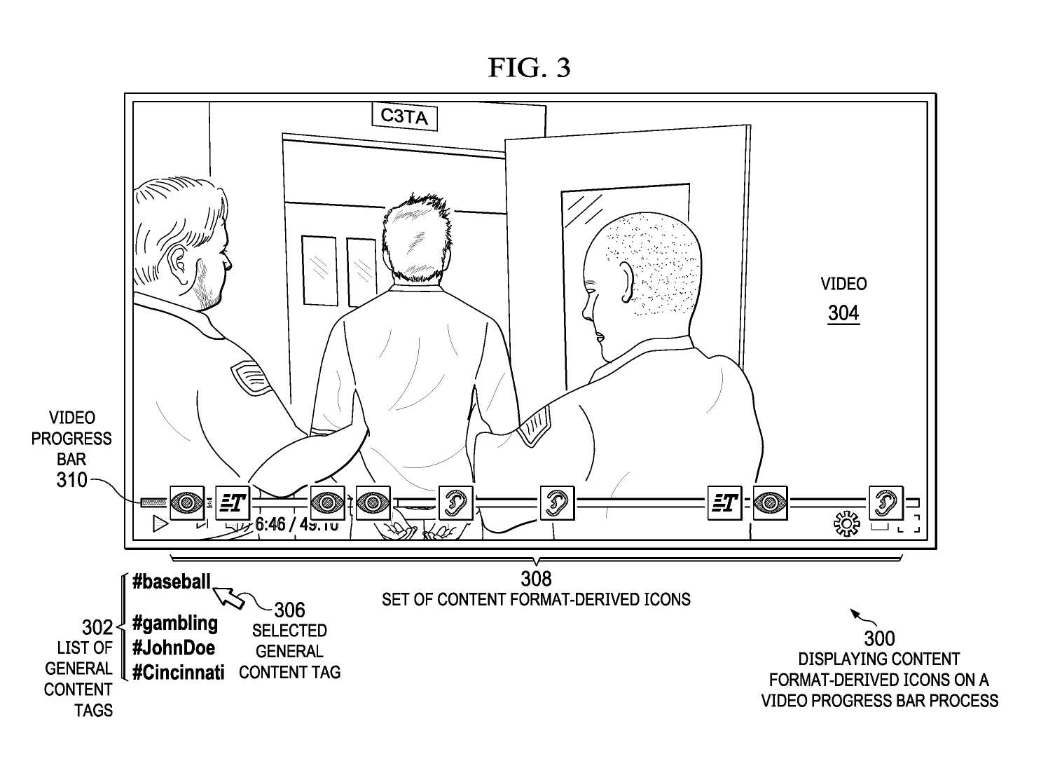

With reference now to FIG. 3, a diagram illustrating display of content format-derived icons on a video progress bar is depicted in accordance with an illustrative embodiment. Displaying content format-derived icons on a video progress bar process 300 displays list of general content tags 302 corresponding to video 304. In this example, list of general content tags 302 includes four different general content #hashtags associated with four different topics referenced within the content of video 304. Also, list of general content tags 302 includes selected general content tag 306, which in this example, is the hashtag #baseball.

Based on selected general content tag 306, displaying content format-derived icons on a video progress bar process 300 displays set of content format-derived icons 308 on video progress bar 310 at locations corresponding to timestamps associated with each instance of selected general content tag 306 in video 304. In this example, set of content format-derived icons 308 includes three different icons, such as a visual (i.e., eye) icon, text (i.e., “T”) icon, and an audio (i.e., ear) icon. In addition, set of content format-derived icons 308 includes four visual icons, two text icons, and three audio icons on video progress bar 310.

Thus, FIG. 3 illustrates one specific example of how illustrative embodiments may display content format-derived icons assigned to a set of sub-content tags/#hashtags on top of a video progress bar. However, it should be noted that FIG. 3 is only intended as an example and not as a limitation on illustrative embodiments. For example, illustrative embodiments may generate and assign any number and type of content format-derived icons for display on a video progress bar. Further, illustrative embodiments may generate and assign any number and type of general content tags to a video.

With reference now to FIG. 4, a diagram illustrating display of sets of content format-derived icons within a list of general content tags is depicted in accordance with an illustrative embodiment. FIG. 4 shows list of general content tags 402, which is similar to list of general content tags 302 in FIG. 3. In addition, list of general content tags 402 includes sets of content format-derived icons 404. In other words, each respective general content tag in list 402 has a corresponding set of content format-derived icons.

In this example, the first general content tag has a corresponding set of three content format-derived icons (i.e., a visual icon, an audio icon, and a text icon). The second general content tag has a corresponding set of two content format-derived icons (i.e., an audio icon and a text icon). The third general content tag has a corresponding set of three content format-derived icons (i.e., a visual icon, an audio icon, and a text icon). The fourth general content tag has a corresponding set of one content format-derived icon (i.e., a text icon). These sets of content format-derived icons denote what type of content sources, such as visual content, audio content, and/or textual content, each respective general content tag in list 402 is derived from.

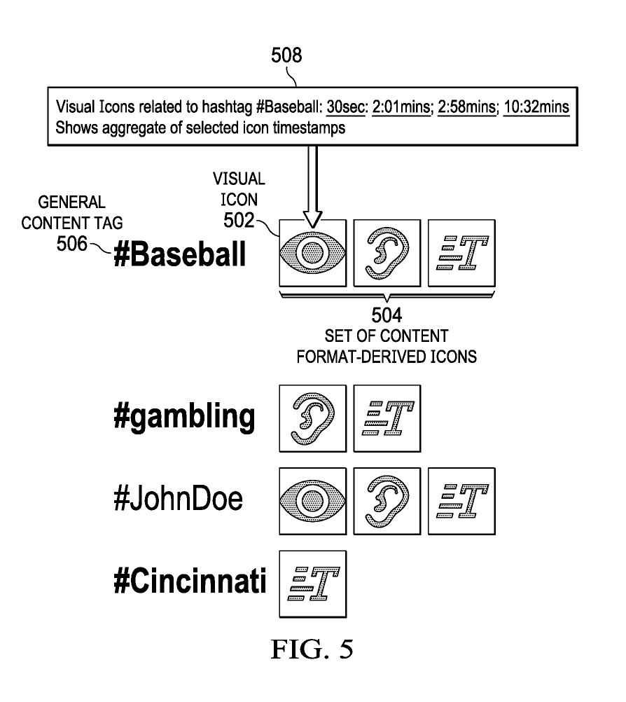

With reference now to FIG. 5, a diagram illustrating display of aggregate icon timestamps is depicted in accordance with an illustrative embodiment. FIG. 5 is similar to FIG. 4 in that FIG. 5 includes a similar list of general content tags and sets of content format-derived icons as FIG. 4. FIG. 5 illustrates the ability of a user to hover over (i.e., select) particular icons within a set to see what visual content, audio content, or textual content is related to each respective general content tag at specific timestamps within a video, such as video 304 in FIG. 3.

In this specific example, the user selects visual icon 502 of set of content format-derived icons 504 corresponding to general content tag 506. In this specific example, general content tag 506 is related to the topic of baseball. As a result of the user selecting visual icon 502, illustrative embodiments show aggregate of selected icon timestamps 508. In this specific example, visual icons related to the topic of baseball are overlaid on the video progress bar at 30 seconds, 2:01 minutes, 2:58 minutes, and 10:32 minutes, similar to the visual icons overlaid on video progress bar 310 in FIG. 3. Thus, illustrative embodiments enable the user to readily see where each instance of visual content regarding the topic of baseball may be found within the video by displaying aggregate of selected icon timestamps 508.

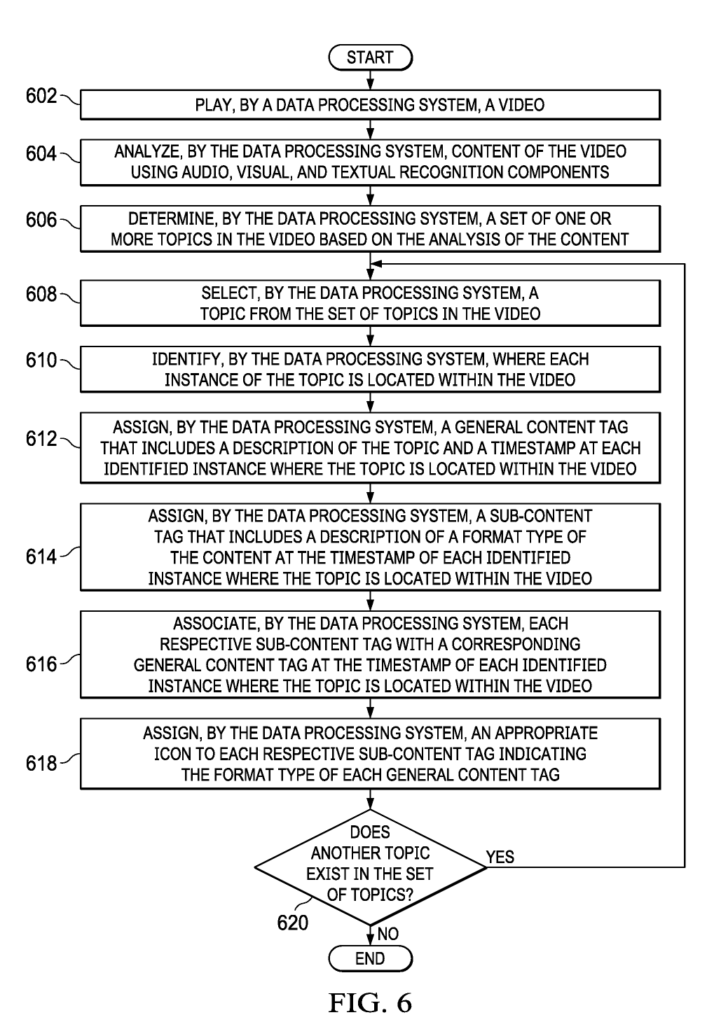

With reference now to FIG. 6, a flowchart illustrating a process for assigning an appropriate content format-derived icon to each respective general content tag within a video is shown in accordance with an illustrative embodiment. The process shown in FIG. 6 may be implemented in a data processing system, such as, for example, data processing system 100 in FIG. 1.

The process begins when the data processing system plays a video (step 602). In addition, the data processing system analyzes content of the video using audio, visual, and textual recognition components (step 604). Further, the data processing system determines a set of one or more topics in the video based on the analysis of the content (step 606).

Afterward, the data processing system selects a topic from the set of topics in the video (step 608). Furthermore, the data processing system identifies where each instance of the topic is located within the video (step 610). Moreover, the data processing system assigns a general content tag that includes a description of the topic and a time stamp at each identified instance where the topic is located within the video (step 612).

The data processing system also assigns a sub-content tag that includes a description of a format type of the content at the time stamp of each identified instance where the topic is located within the video (step 614). In addition, the data processing system associates each respective sub-content tag with a corresponding general content tag at the time stamp of each identified instance where the topic is located within the video (step 616). Further, the data processing system assigns an appropriate icon to each respective sub-content tag indicating the format type of each general content tag (step 618).

Then, the data processing system makes a determination as to whether another topic exists in the set of topics (step 620). If the data processing system determines that another topic does exist in the set of topics, yes output of step 620, then the process returns to step 608 where the data processing system selects another topic in the video. If the data processing system determines that another topic does not exist in the set of topics, no output of step 620, then the process terminates thereafter.

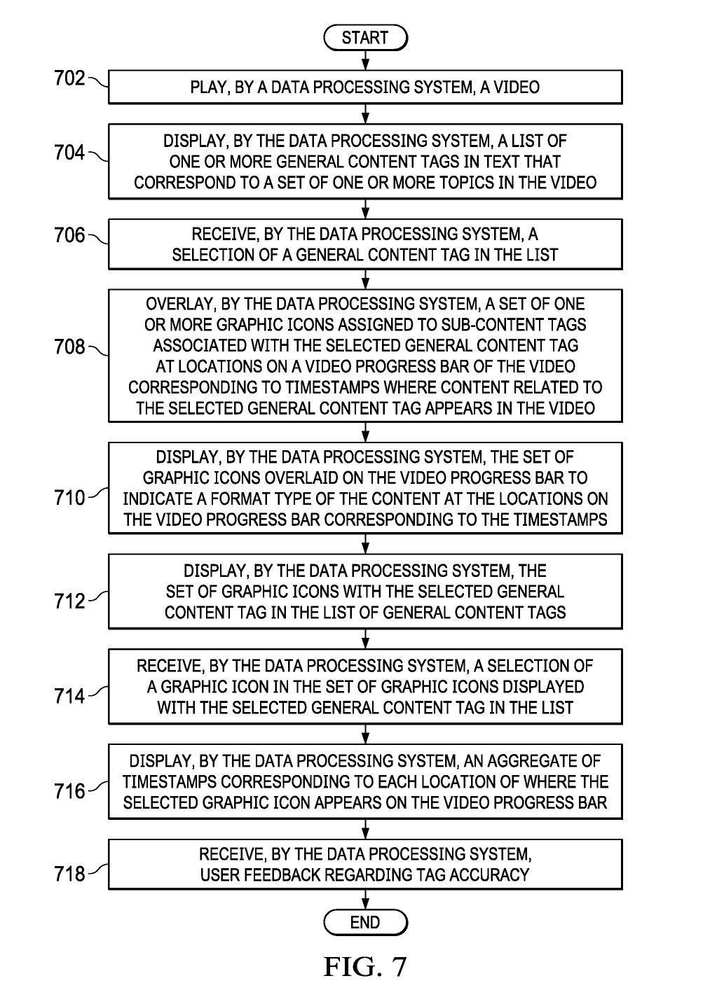

With reference now to FIG. 7, a flowchart illustrating a process for displaying a set of content format-derived icons on a video progress bar is shown in accordance with an illustrative embodiment. The process shown in FIG. 7 may be implemented in a data processing system, such as, for example, data processing system 100 in FIG. 1.

The process begins when the data processing system plays a video (step 702). In addition, the data processing system displays a list of one or more general content tags in text that correspond to a set of one or more topics in the video (step 704). Subsequently, the data processing system receives a selection of a general content tag in the list (step 706).

Afterward, the data processing system overlays a set of one or more graphic icons assigned to sub-content tags associated with the selected general content tag at locations on a video progress bar of the video corresponding to timestamps where content related to the selected general content tag appears in the video (step 708). Further, the data processing system displays the set of graphic icons overlaid on the video progress bar to indicate a format type of the content at the locations on the video progress bar corresponding to the timestamps (step 710). Furthermore, the data processing system displays the set of graphic icons with the selected general content tag in the list of general content tags (step 712).

Subsequently, the data processing system receives a selection of a graphic icon in the set of graphic icons displayed with the selected general content tag in the list (step 714). Then, the data processing system displays an aggregate of timestamps corresponding to each location of where the selected graphic icon appears on the video progress bar (step 716). Afterward, the data processing system receives user feedback regarding tag accuracy (step 718). Thereafter, the process terminates.

Thus, illustrative embodiments of the present invention provide a computer-implemented method, data processing system, and computer program product for determining a topic in a video by analyzing the content of the video, generating a general content tag corresponding to the topic and a set of content format-derived tags identifying a type of format the general content tag is derived from, such as visual content, audio content, and/or textual content, within the video, and identifying the specific locations where respective content format-derived tags are located within the video using corresponding graphic icons, such as visual icons, audio icons, and/or text icons, on a progress bar of the video. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for visualizing where and how a tag was generated for a video being played, the method comprising:
determining topics in a video by evaluating content of the video using audio, visual, and text recognition;
for each instance in the video where a topic is determined to appear:
(a) assigning a general tag that includes a description of the topic and a timestamp indicating where the general tag appears in the video, and
(b) assigning a sub-content tag that includes a description of a format type of the content at a location in the video corresponding to the timestamp of the general tag, wherein the sub-content tag is associated with the general tag; and
displaying either general tags or sub-content tags when rendering the video, wherein the general tags are displayed in text and the sub-content tags are displayed as icons indicating the format type of each of the general tags.

2. The method of claim 1, wherein the displaying further comprises:
overlaying the sub-content tags on a video progress bar for the video at locations on the video progress bar corresponding with the timestamp where the content related to the general tag appears in the video.

3. The method of claim 1, wherein the displaying further comprises:
displaying a list of the general tags;
receiving a selection of a general tag in the list; and
responsive to the selection, overlaying a set of sub-content tags corresponding with the selected general tag on a video progress bar for the video at locations on the video progress bar corresponding with each respective timestamp where content related to the selected general tag appears in the video.

4. The method of claim 1, wherein the displaying further comprises:
displaying a list of general tags and a set of sub-content tags associated with each respective general tag in the list; and
responsive to a selection of a sub-content tag in the set, displaying an aggregate of timestamps corresponding to each location where the selected sub-content tag appears on a progress bar for the video.

5. The method of claim 1, wherein the general tags and the sub-content tags are determined for live streaming video.

6. The method of claim 1 further comprising:
receiving user feedback regarding tag accuracy.

7. The method of claim 1, wherein the determining of the topics in the video by evaluating the content of the video also includes using facial and gesture recognition.

8. A data processing system for visualizing where and how a tag was generated for a video being played, the data processing system comprising:
a bus system;
a storage device connected to the bus system, wherein the storage device stores program instructions; and
a processor connected to the bus system, wherein the processor executes the program instructions to:
determine topics in a video by evaluating content of the video using audio, visual, and text recognition;
for each instance in the video where a topic is determined to appear:
(a) assign a general tag that includes a description of the topic and a timestamp indicating where the general tag appears in the video, and
(b) assign a sub-content tag that includes a description of a format type of the content at a location in the video corresponding to the timestamp of the general tag, wherein the sub-content tag is associated with the general tag; and
display either general tags or sub-content tags when rendering the video, wherein the general tags are displayed in text and the sub-content tags are displayed as icons indicating the format type of each of the general tags.

9. The data processing system of claim 8, wherein displaying further comprises the processor further executing the program instructions to:
overlay the sub-content tags on a video progress bar for the video at locations on the video progress bar corresponding with the timestamp where the content related to the general tag appears in the video.

10. The data processing system of claim 8, wherein displaying further comprises the processor further executing the program instructions to:
display a list of the general tags;
receive a selection of a general tag in the list; and
overlay a set of sub-content tags corresponding with the selected general tag on a video progress bar for the video at locations on the video progress bar corresponding with each respective timestamp where content related to the selected general tag appears in the video in response to the selection.

11. The data processing system of claim 8, wherein displaying further comprises the processor further executing the program instructions to:
display a list of general tags and a set of sub-content tags associated with each respective general tag in the list; and
display an aggregate of timestamps corresponding to each location where the selected sub-content tag appears on a progress bar for the video in response to a selection of a sub-content tag in the set.

12. The data processing system of claim 8, wherein the general tags and the sub-content tags are determined for live streaming video.

13. The data processing system of claim 8, wherein the processor further executes the program instructions to:
receive user feedback regarding tag accuracy.

14. A computer program product for visualizing where and how a tag was generated for a video being played, the computer program product comprising a computer readable storage medium having program instructions embodied therewith, the program instructions executable by a data processing system to cause the data processing system to perform a method comprising:
determining topics in a video by evaluating content of the video using audio, visual, and text recognition;
for each instance in the video where a topic is determined to appear:
(a) assigning a general tag that includes a description of the topic and a timestamp indicating where the general tag appears in the video, and
(b) assigning a sub-content tag that includes a description of a format type of the content at a location in the video corresponding to the timestamp of the general tag, wherein the sub-content tag is associated with the general tag; and
displaying either general tags or sub-content tags when rendering the video, wherein the general tags are displayed in text and the sub-content tags are displayed as icons indicating the format type of each of the general tags.

15. The computer program product of claim 14 further comprising:
overlaying the sub-content tags on a video progress bar for the video at locations on the video progress bar corresponding with the timestamp where the content related to the general tag appears in the video.

16. The computer program product of claim 14, wherein the displaying further comprises:
displaying a list of the general tags;
receiving a selection of a general tag in the list; and
responsive to the selection, overlaying a set of sub-content tags corresponding with the selected general tag on a video progress bar for the video at locations on the video progress bar corresponding with each respective timestamp where content related to the selected general tag appears in the video.

17. The computer program product of claim 14, wherein the displaying further comprises:
displaying a list of general tags and a set of sub-content tags associated with each respective general tag in the list; and
responsive to a selection of a sub-content tag in the set, displaying an aggregate of timestamps corresponding to each location where the selected sub-content tag appears on a progress bar for the video.

18. The computer program product of claim 14, wherein the general tags and the sub-content tags are determined for live streaming video.

19. The computer program product of claim 14 further comprising:
receiving user feedback regarding tag accuracy.

20. The computer program product of claim 14, wherein the determining of the topics in the video by evaluating the content of the video also includes using facial and gesture recognition.
